(19) United States
(12) Patent Application Publication
(10) Pub. No.: US 2025/0185697 A1
(43) Pub. Date: Jun. 12, 2025

(54) NOVEL STARCH-BASED COMPOSITIONS, MANUFACTURING METHODS, AND APPLICATIONS THEREOF

(71) Applicant: ARCHER-DANIELS-MIDLAND COMPANY, Decatur, IL (US)

(72) Inventors: Alex Sanborn, Lincoln, IL (US); Ali Ayoub, Decatur, IL (US)

(21) Appl. No.: 18/844,920

(22) PCT Filed: Dec. 15, 2022
(86) PCT No.: PCT/US2022/081657

§ 371 Date: Sep. 6, 2024

(51) Int. Cl. A23L 11/70; A23K 10/30; A23K 20/147; A23K 40/10; A23K 40/25; A23L 29/212; A23L 33/21; A23P 30/20

(52) U.S. Cl. CPC A23L 11/70; A23K 10/30; A23K 20/147; A23K 40/10; A23K 40/25; A23L 29/212; A23L 33/21; A23P 30/20

(57) ABSTRACT

Described herein are starch containing compositions and methods of making from pulse crops such as lentils, peas and beans that have a unique composition of starch, protein and fiber that makes them suitable for use in formulating meat analogue products. An illustrative example is a pea starch composition that is about 50 to 85 weight percent starch; about 4 to 30 weight percent fiber; and about 5 to 15 weight percent protein. In exemplary embodiments the pea starch particle product has a particle size of 30 to 300 microns in diameter. The product is made by a method that includes a) drying a pea starch product to form a powder; (b) mixing the powder with water, producing a mixture; (c) extruding the mixture thru an extruder producing an extrudate; and d) grinding the extrudate to the desired particle size.

### TECHNICAL FIELD

The present invention relates generally to novel starch-based compositions, manufacturing methods and applications thereof. More particularly, the present invention relates to a pea starch particle produced by physical means, without any addition of chemicals or enzymes, and its use in animal feed, human food products, and non-food products.

### BACKGROUND OF THE INVENTION

Consumer interest in meat analogues has expanded steadily over the years, as more people strive to maintain a nutritious and balanced diet. The global market value of meat analogues is expected to grow to over 35 billion U.S. dollars by 2027. Meat analogues are mainly popular among consumers who prefer plant-based products over animal protein for various reasons including the concerns of animal-borne disease and unethical animal practices.

Most meat analogue products contain a chemically modified derivative of cellulose (i.e. methyl cellulose), which acts as a binder providing adhesion to the uncooked product, and when heated, gels to a meat like texture with firmness and juiciness. However, methyl cellulose is chemically synthesized from cellulose, methyl chloride and concentrated sodium hydroxide solution and is the main active ingredient in various laxatives. Therefore, concerns of methyl cellulose not being a chemical-free binder and related risks necessitate the development of novel chemical-free binding systems for consumers from plant-based materials. The physical properties of existing plant-based meat analogs are still inferior to those of animal-based meat, especially when referring to texture, hardness, and juiciness. These properties are crucial for the consumers' acceptance of food products and, hence, remain a critical obstacle. Another challenge for plant-based meat analogs is the presence of anti-nutritional factors, such as protease inhibitors, tannins, and phytates. These factors decrease the digestibility and bioavailability of plant proteins compared with animal proteins. Based on the above issues, there are many remaining challenges in making plant-based meat analogs available to a wide range of consumers.

Starch is an attractive ingredient for use in food and non-food industries due to its cheapness, biodegradability, abundance, and non-toxic properties. Starches are natural occurring ingredients made from agricultural feedstocks. Because starch is environmentally friendly, starch particles have received commercial interest and have been suggested as a promising ingredient in a variety of fields including foods, beverages, coatings, cosmetics, and pharmaceuticals, as well as various composites as used in food and industrial applications.

Native starches typically have poor solubility in cold water and high viscosity when gelatinized. These inherent inadequacies limit the use of native starches and the starches must be subjected to physical, chemical, enzymatic modification or combinations thereof. Amongst these modifications, physical methods are more acceptable since they are chemical-free and therefore considered safer for human consumption. Physical modification of starch is connected to the concept of green technology or sustainable technology for environmentally friendly applications.

Various attempts have been made to make meat analogues using native starch-based and chemical-free modifications. Production of low-sodium type pea protein meat analogues by means of a one specific technique is disclosed in CN111567573A. This method is very complex and involves many steps including the extraction of protein, solid-liquid separation, extraction of starch containing dietary fiber, mixing of protein, starch, and fiber, adjusting and regulating pH, drying and sieving powder, extruding and puffing, shaping, drying and packaging. The process involves five grinding steps wherein the raw material must be passed through a dry grinding machine for coarse grinding and inputting the material into a wet grinding machine for secondary grinding, and recirculating the ground material three times, to strip all the protein, starch, and fiber, adding appreciably to the cost of the process. Each step in the process includes additional steps making the process even more complex and less efficient. Moreover, starch and fiber are extracted from pea protein and starch and fiber are separated, only to be mixed together and the mixture spray dried. Mixing of protein, starch, and fiber requires careful regulation of pH and prolonged mixing to achieve uniform distribution of the starch and fiber throughout the protein, which can result in poor texture and meat analogue product.

CN104187790A discloses a pea protein powder, application and a production method of the pea protein powder. The pea protein powder comprises 80-90% protein, 5-8% fat, 0.5-1% fiber, and 2-4% starch and applied to meat product processing. Separation of pea protein, pea fiber, and pea starch is performed by an isoelectric process wherein the method for separating the pea protein powder comprises a) screening of raw materials by a classification machine, b) cleaning and mixing with the pea raw material, c) soaking and acidifying for at least 48 hours, d) grinding by mechanical means, e) centrifugal separating, f) carrying out a double heat exchange, g) spraying at 50° C.) separating protein from water by a horizontal spiral discharge sedimentation centrifuge, i) emulsifying, j) adjusting pH to 7.5-8.0 to dissolve pea protein followed by centrifuging, k) precipitating by acid treatment, l) sterilizing and deodorizing by flash evaporation, m) homogenizing by a high pressure homogenizer, n) spray drying o) packaging.

The yield of the protein powder, prepared by isoelectric precipitation is influenced by several factors such as particle size of the powder, the kind of solubilizing agent, as well as pH of solubilization and precipitation. No product yield is disclosed. The powder composition is affected by the solubilizing and the pH adjustment for precipitating. Furthermore, the physicochemical or functional properties of the pea protein powder such as protein solubility, viscosity, emulsifying capacity, color, taste, or smell are heavily influenced by variations of the separation process. The publication describes the disadvantages of the pea protein powder in the meat product and suggests the weight proportion of the pea protein product in the meat product to be less than 4% to “avoid the peculiar smell and color of the pea protein powder.” Moreover, the pea protein product has large particle size and problems of “loose product tissue structure, poor slicing property, visible particles in meat block gaps and the like can be caused.” The concentration of pea fiber is very limiting to obtain the viscoelasticity and hardness of the product, otherwise, thickening agents must be added.

In CN104256402A, describes a variation of the above method that includes after the centrifugal separating step, filter press dewatering to precipitate a crude pea powder, drying the powder residue, and packing. The disclosed pea fiber product comprises 70-80% edible fiber, 8-12% pea protein, and 8-12% starch and is applied to meat analogue product processing. Though this method has proven quite useful, certain inherent shortcomings remain in its use. For example, among the more prevalent shortcomings encountered, when utilizing several drying methods are, at times, low yield, greater exposure to possible contamination, and high maintenance costs. Another important limitation is the methods include pH adjustment which is difficult to control, wherein the effect of temperature, time, concentration, and devices influence the composition and negatively affect the quality of products, thus making them unsuitable for commercial applications.

Several methods have been developed to modify starches for use in food formulations. However, attempts to produce starch-based compositions and subsequent powder properties for use in a variety food and non-food applications have suffered from one or more problems, such as process complexity and expense. Thus, a need exists for a clean-label starch product that can mimic the functionality of methylcellulose in the meat alternative business.

### BRIEF SUMMARY OF THE INVENTION

The process and compositions disclosed herein provide compositions having desirable meat analogue properties. In addition to meat analogues, the compositions of this invention can be used in other food formulations including but not limited to sausages, noodles, batter, muffins, cookies, crackers, puddings, sauces, soups, mayonnaise, yogurt, frozen foods, ready to eat foods, baby food, dry mixes, and snack foods such as soft candies, marshmallows, and granola bars. The compositions may also be used in many non-food formulations including but not limited to plastics, paints, varnishes, corrugated boards, cat litter, construction, meat packaging, diapers, gypsum, dog treats, pet foods, paper, textiles, charcoal, lotions, creams, drugs, and cosmetics.

The invention further relates to the design and use of the process parameters to enable the formation of new and unique starch-based compositions and subsequent powder properties for use in a variety food and non-food applications.

Accordingly, the present invention is directed to a pea starch particle product which comprises about 50 to 85 weight percent starch; about 4 to 30 weight percent fiber; and about 5 to 15 weight percent protein; wherein the pea starch particle product has a particle size of 30 to 300 microns in diameter.

In another embodiment, an objective was to produce pea starch particle products by milling, extrusion, roll pressing, grinding, sieving and combinations thereof.

In certain embodiments, the pea starch particle product has a water solubility from about 20% to about 95% and a final viscosity from about 300 centipoise to about 2000 centipoise.

In another aspect, a method of forming a pea starch particle product is provided that comprises (a) drying a pea starch product to form a powder; (b) mixing the powder with water, producing a mixture; (c) extruding the mixture through an extruder; and (d) grinding the extrudate producing the pea starch particle product. In an embodiment, in forming the pea starch particle product the pea starch is not treated to any chemical or enzyme reaction.

In another embodiment, the powder comprises at least about 4% by weight fiber. In an embodiment, the powder has been subjected to milling prior to extruding. In a certain embodiment, extruding is with a single screw or a twin-screw extruder. In another embodiment, extruding is carried out at a temperature from about 80° C. to about 150° C. In still another embodiment, extruding is carried out at a screw speed from about 100 rpm to about 500 rpm.

In another aspect, a method of making an animal feed or human food product is provided that comprises obtaining a recipe for the animal feed or human food product with methyl cellulose as an ingredient and substituting the methyl cellulose with the pea starch particle product. In certain embodiments, a non-food product, animal feed, or human food product comprises the pea starch particle product. In another embodiment, a method of making an animal feed or human food product comprises obtaining a recipe for the animal feed or human food product with oat fiber as an ingredient and substituting the oat fiber with the pea starch particle product.

In an embodiment, the animal feed or human food product comprises the pea starch particle product in combination with a native starch material. In certain embodiments, the native starch material is selected from the group consisting of corn, potato, rice, wheat, tapioca, and combinations thereof.

These and other aspects, embodiments, and associated advantages will become apparent from the following Detailed Description.

### DETAILED DESCRIPTION OF THE INVENTION

### Section I—Terminology

Before describing the present invention in detail, it is understood that unless explained otherwise, all technical and scientific terms used herein have the same meaning as commonly understood to one of ordinary skill in the art to which this disclosure belongs. The materials, methods, and examples are illustrative only and not intended to be limiting.

As used in this specification, and the appended claims, the singular forms “a,” “an,” and “the” include the plural references and the term “comprising” means “including” unless the context clearly indicates otherwise. The term “or” refers to a single element of stated alternative elements or a combination of two or more elements unless the context clearly indicates otherwise. In the context of the present invention, the term “and/or” includes any single elements as well as all possible combinations of the elements cited in the respective list. Unless defined otherwise in context, all technical and scientific terms used herein have their usual meaning, conventionally understood by persons skilled in the art to which the present invention pertains.

In the present application, including the claims, other than in the operating examples or where otherwise indicated, all numbers expressing quantities or characteristics are to be understood as being modified in all instances by the term “about” or “approximately.” Accordingly, unless indicated to the contrary, any numerical parameters set forth in the following description may vary depending on the desired properties one seeks to obtain in the compositions and methods according to the present disclosure. All temperatures given are in degrees Celsius (degrees C.). All percentages, unless otherwise stated refer to the percentage by weight (wt %). The term “particles” used herein may also be referred to as “extrudates.” In the context of the present invention, “dry” means that less than 5% of free water is present in the composition the invention. Nevertheless, the powder, product, or particle may contain a certain amount of water which is bound within the particles of the composition. Other abbreviations in this context include “B1” batch 1, “B2” for batch 2, and “MC” for methyl cellulose.

“Native starch” means a starch as it exists in the plant at harvest and upon extraction with very minimal physical, chemical, enzyme treatment.

As used herein, a “starch particle product” or “starch extrudate” or “starch-based composition” refers to a particulate material that is about 50 to 85 weight percent starch; about 4 to 30 weight percent fiber; and about 5 to 15 weight percent protein.

A “coarse” particle preferably has an average particle size of greater than 700 microns.

A “fine” particle preferably has an average particle size of less than 700 microns.

### Section II—Analysis Methods

Rheology Behavior. The viscosity profile of inhibited starches was analyzed using Rapid Visco Analyzer (RVA) from Perten Instruments. The viscosity profile was obtained using a 10% dry solids (DS) solution in neutral buffer (pH 6.5) according to the following regime: initial temperature of 25° C., mixing at 960 rpm for 15 seconds and then at 160 rpm for the whole profile, heating to 95° C. at a rate of 14° C./minute, holding at 95° C. for 7 minutes, cooling to 50° C. at a rate of 4.5° C./minute and mixing for 10 minutes at 50° C. The value of starting viscosity was detected from the viscosity profile when the differential in viscosity was less than 1.2 cp/s during heating cycle; ending viscosity at 95° C. as defined as the viscosity at the end of heating cycle at 95° C.; slope viscosity was defined between starting and end viscosity at 95° C. over time; and a final viscosity at 50° C. was the concluding viscosity after cooling cycle and mixing for 10 minutes.

Water solubility. In accordance with a preferred method for determining water solubility, 4.0 g (dry basis) product is dispersed in 80.0 g of distilled water. After stirring for 10 minutes at 25° C., the slurry is transferred into a 100 mL graduated cylinder and diluted to volume. The graduated cylinder is inverted three times and allowed to sit at 25° C. for 12 min. One 20 g aliquot of the supernatant is then transferred to a pre-weighed pan. The pan is then placed on a hot plate to be evaporated to dryness. The pan is then weighed and recorded as a dry sample weight. Solubility is calculated using the following formula:

Solubility=[(dry sample weight)/0.8*100].

Particle size. The particle size was analyzed using Malvern Mastersizer 3000 module. Effect of different processing formulations on particle size of sieved and unsieved pea starch particle products is shown in Table 9. Results are an average of three measurements. The parameter D50 is the size in microns at which 50% of the sample is smaller and 50% is larger, D90 gives the size of particle below which 90% of the sample lies.

### Section II—Description

The embodiments disclosed herein are directed to compositions and methods that comprise starch, fiber, and protein. In various embodiments, the composition is about 50 to 85 weight percent starch; about 4 to 30 weight percent fiber; and about 5 to 15 weight percent protein. The disclosed pea starch particle product has a particle size of 30 to 300 microns in diameter.

In an embodiment, the method of forming a pea starch particle product comprises: (a) drying a pea starch product to form a powder, (b) mixing the powder with water, producing a mixture; (c) extruding the mixture through an extruder producing an extrudate; and (d) grinding the extrudate producing the pea starch particle product.

In step (a) the pea starch product is dried to form a powder. Any suitable method to dry the product can be used including but not limited to freeze drying, drum drying, flash drying, spray drying, oven treatment, filtering or a combination thereof. The dry powder is the coarse fraction. The coarse fraction optionally can be milled, ground, and/or sieved to reduce its particle size.

In step (b) mixing may be batch or continuous mixing. Mixing preconditions the starch product to achieve characteristics, such as moisture content, pH, and temperature, desirable for further processing of the material.

In step (c) those skilled in the art having the benefit of the present disclosure will recognize that suitable extruder systems useful for the present invention are not limited to a screw variety, and may also include, for example, single screw, twin-screw, ram, or other similar extrusion methods. The configuration of the screw elements can be varied to modify the operating properties of the extruder and the properties of the products of the invention. Other processing methods may be used including jet milling, milling, or a combination thereof. Processing may also be used with the introduction of air into the processing system including but not limited to cavitation. Subsequently in step d) the extrudate is broken apart by grinding, but may be subjected to roll pressing, or milling, and combinations thereof.

In an embodiment, the pea starch is not treated to any chemical or enzyme reaction.

The non-chemical and non-enzymatic modified process disclosed herein may be used to produce the unique starch-based compositions from starch or de-germed flour, or a combination thereof, and water or steam, or a combination thereof. An exemplary, but not limiting, starch is pea starch. Native starch materials suitable for use in the present invention include, but are not limited to corn, potato, rice, wheat, tapioca, and combinations of any thereof. An exemplary de-germed flour is de-germed corn flour. The starch of de-germed flour may be derived from a plant source selected from the group consisting of corn, wheat, peas, rice, tapioca, potatoes and other cereal grains such as rye, barley, and oat as well as from certain legumes such as soybeans, peanuts, and combinations thereof.

Those skilled in the art will recognize that with the benefit of aspects of the disclosure herein, this technology can be applied to a variety of cereal/grain flours and starch/flour compositions to obtain physically modified starches, and model/real food application comprising the physically modified starches, with desirable characteristics. The characteristics of the extrudates can be tailored by altering the processing conditions. Such desirable characteristics may include, but are not limited to, viscosity, water solubility, water absorbency, particle size, gelatinization temperature, and any combination thereof. Those skilled in the art will recognize that with the benefit of aspects of the disclosure herein, a viscosity profile as a function pH, and having desired shear characteristics can be obtained in a food or non-food application.

The starch-based compositions disclosed herein function to provide structure, viscosity, texture, and acceptable attributes to replace methyl cellulose and other more costly starches when used in meat analogues and bakery applications. The compositions lack off-flavors and do not mask the foods inherent flavors when added to a food formulation. The starch-based compositions have been produced with both laboratory and commercial plant processing schemes and equipment.

One aspect of the proposed invention relates to applications of the disclosed novel starch-based compositions. More particularly, the inventors have shown the disclosed starch-based compositions function in meat analogues as a complete replacement for methyl cellulose (MC). A patty formulated with the disclosed composition was preferred in sensory attributes compared to a patty made with methyl cellulose. The product formulated with the composition was more meat-like, whereas the MC patty was more elastic, chewy, and firm. The disclosed starch-based compositions enable a successful replacement of full-fat counterparts and allow the consumer preference of meat doneness. The patty formulated with MC showed burning while those with pea starch composition varied in the ranking of degrees of doneness. This attribute is not seen using MC. The present invention has shown that composition is important to achieving a texture that can replace MC in foods.

In addition to food applications, the compositions of this invention can be incorporated into non-food formulations, including but not limited to creams, plastics, inks, paper, corrugated board, cosmetics, lotions, textiles, charcoal, varnishes, shellacs, and drugs. The compositions can also be used in biofertilizers, and in personal care and home care products as film forming agents and stabilizing agents.

### Examples

The following exemplary, non-limiting examples are provided to further describe the embodiments presented herein. Those having ordinary skill in the art will appreciate that variations of these Examples are possible within the scope of the invention.

### Materials

The pea starch product was obtained from the pea protein plant of Archer Daniels Midland (ADM) in Enderlin, ND.

### Extrusion Process

The pea starch product was subjected to extrusion after mixing with water with shear and gentle heating to achieve a slurry. The water may be added in the form of steam or liquid water. Over the course of the processing, the temperature was in the range of 25° Celsius (i.e., room temperature) to less than 200° Celsius, preferably in the range of in the range of 25° Celsius to less than 140° Celsius. Starch-based compositions demonstrating unique properties for use in food and non-food applications were produced using a pilot scale TX-57 Magnum co-rotating two screw extruder system (Wenger Manufacturing, Sabetha, KS) that can be fitted with screw shafts and barrels of varying lengths and equipped with water cooling capability and steam heating. A low shear screw configuration identified as conventional screw configuration (conveying screws) or a high shear screw configuration was used. A high shear configuration with the screw elements in the extruder was selected with the goal of keeping the pressure in the barrel as high as possible over a short distance.

Different parameters which were designed and prepared for the development and evaluation of the pea starch particle products in accordance with aspects of this invention, and these formulations are summarized in Table 1. Pea starch extrudates were prepared using either coarse pea starch or fine pea starch at a feed rate of 90 pounds per hour. Several variables were investigated during the extrusion process including pea starch product (coarse or fine), moisture content, screw speed, and mechanical shear.

TABLE 1
Extrusion parameters for processing of pea starch
products into pea starch particle products.

| | | | | |
|---|---|---|---|---|
| | | | Moisture | |
| Experiment | Pea Starch | Mechanical | Content | Screw Speed |
| # | Product | Shear | (mL/min) | (rpm) |

Batch 1 (B1)

| | | | | |
|---|---|---|---|---|
| B1-1 | Coarse | Low | 200 | 400 |
| B1-2 | Coarse | Low | 300 | 400 |
| B1-3 | Coarse | Low | 150 | 400 |
| B1-4 | Coarse | Low | 100 | 400 |
| B1-5 | Coarse | Low | 400 | 100 |
| B1-6 | Coarse | Low | 300 | 150 |
| B1-7 | Fine | Low | 200 | 400 |

Batch 2 (B2)

| | | | | |
|---|---|---|---|---|
| B2-1 | Coarse | High | 200 | 400 |
| B2-2 | Coarse | High | 300 | 400 |
| B2-3 | Coarse | High | 150 | 400 |
| B2-4 | Coarse | High | 400 | 400 |
| B2-5 | Fine | High | 300 | 400 |
| B2-6 | Fine | High | 200 | 400 |
| B2-7 | Fine | High | 300 | 150 |
| B2-8 | Fine | High | 150 | 400 |
| B2-9 | Fine | High | 300 | 300 |
| B2-10 | Fine | High | 200 | 200 |

The starch extrudates were collected and subjected to drying in the oven. The extrudates were ground and, optionally, subjected to sieving to produce starch particle products. The starch particle products had varied functional properties, i.e., rheology behavior, water absorbency, composition, and particle size.

Viscosity directly affects the product applicability and reflects the effects of processing conditions on the final particle products. Viscosity characteristics analyzed by RVA viscoamylographs are shown in Tables 2 and 3 for coarse pea starch, fine pea starch, and sieved and unsieved pea starch product particles. Products showing high final viscosity were obtained by subjecting a fine feed to a high shear configuration, with increased moisture levels, and lower screw speed. Those skilled in the art will recognize that with the benefit of this disclosure, the selection of processing parameters and optionally sieving the particle product, allows for fine-tuning of viscosity characteristics.

TABLE 2
Viscosity profiles provided by RVA viscoamylographs
(Batch 1, low shear).

| | Peak Viscosity | Final Viscosity |
|---|---|---|
| Sample | (cps) | (cps) |
| Coarse Pea Starch | 251 | 531 |
| Fine Pea Starch | 444 | 824 |
| B1-1 unsieved | 402 | 662 |
| B1-1 sieved | 341 | 505 |
| B1-2 unsieved | 461 | 748 |
| B1-2 sieved | 320 | 479 |
| B1-3 unsieved | 598 | 695 |
| B1-3 sieved | 235 | 628 |
| B1-4 unsieved | 341 | 576 |
| B1-4 sieved | 325 | 602 |
| B1-5 unsieved | 526 | 795 |
| B1-5 sieved | 495 | 817 |
| B1-6 unsieved | 707 | 1044 |
| B1-6 sieved | 561 | 951 |
| B1-7 unsieved | 622 | 963 |
| B1-7 sieved | 455 | 908 |

TABLE 3
Viscosity profiles provided by RVA viscoamylographs
(Batch 2, high shear).

| | Peak Viscosity | Final Viscosity |
|---|---|---|
| Sample | (cps) | (cps) |
| Coarse Pea Starch | 251 | 531 |
| Fine Pea Starch | 444 | 824 |
| B2-1 unsieved | 445 | 727 |
| B2-1 sieved | 392 | 755 |
| B2-2 unsieved | 371 | 977 |
| B2-2 sieved | 407 | 879 |
| B2-3 unsieved | 319 | 416 |
| B2-3 sieved | 342 | 224 |
| B2-4 unsieved | 491 | 958 |
| B2-4 sieved | 317 | 472 |
| B2-5 unsieved | 473 | 1062 |
| B2-5 sieved | 374 | 1092 |
| B2-6 unsieved | 274 | 272 |
| B2-6 sieved | 258 | 118 |
| B2-7 unsieved | 883 | 1426 |
| B2-7 sieved | 230 | 377 |
| B2-8 unsieved | 631 | 686 |
| B2-8 sieved | 417 | 695 |
| B2-9 unsieved | 1036 | 1726 |
| B2-9 sieved | 526 | 1074 |
| B2-10 unsieved | 570 | 349 |
| B2-10 sieved | 256 | 834 |

The values water solubility (WS) and water absorption index (WAI) show how the product interacts with water and are useful indicators of how the extrudates will perform in the mouth. Native starch granules are insoluble in cold water. After processing through extrusion, the starch granules start to absorb water, swell, and gelatinize. Subsequently, gelatinized starch is partly soluble in water. The WS results, which are shown in Table 4 below, indicate that extrusion significantly increases WS. In most cases, water solubility increased with an increase in the process screw speed. The water solubilities of the products of the invention are manipulated by controlling the conditions of extrusion such as the moisture content, mechanical shear, screw speed, and material in the extruder and the die plate temperature and pressure of the extruder.

TABLE 4
Water solubility characteristics.

| | Water | | | Moisture |
|---|---|---|---|---|
| | Solubility | Screw Speed | Mechanical | Content |
| Sample | (g/mL) | (rpm) | Shear | (mL/min) |
| Coarse Pea Starch | 3.7 | As control | | |
| B1-2 sieved | 39.63 | 400 | Low | 300 |
| B1-6 sieved | 23.75 | 150 | Low | 300 |
| Fine Pea Starch | 6.9 | As control | | |
| B2-6 unsieved | 57.15 | 400 | High | 200 |
| B2-10 unsieved | 38.75 | 150 | High | 200 |

The table given below shows the pea starch particle products formed during the extrusion have significantly higher water absorbency than either the coarse pea starch or fine pea starch control feed. WAI values ranged from 3.18 to 5.99 g/g. The processing conditions have an obvious impact on the water absorbency of the extrudates.

TABLE 5
Water absorbency characteristics.

| | Water Absorbency |
|---|---|
| Sample | Index (WAI) |
| Coarse Pea Starch | 3.36 |
| Fine Pea Starch | 2.42 |
| B1-1 unsieved | 4.98 |
| B1-1 sieved | 5.13 |
| B1-2 unsieved | 4.41 |
| B1-2 sieved | 4.56 |
| B1-3 unsieved | 5.59 |
| B1-3 sieved | 5.01 |
| B1-4 unsieved | 4.74 |
| B1-4 sieved | 5.15 |
| B1-5 unsieved | 3.82 |
| B1-5 sieved | 3.18 |
| B1-6 unsieved | 4.12 |
| B1-6 sieved | 3.87 |
| B1-7 unsieved | 5.66 |
| B1-7 sieved | 5.99 |
| B2-1 unsieved | 4.98 |
| B2-1 sieved | 5.13 |
| B2-2 unsieved | 4.41 |
| B2-2 sieved | 4.56 |
| B2-3 unsieved | 5.59 |
| B2-3 sieved | 5.01 |
| B2-4 unsieved | 4.74 |
| B2-4 sieved | 5.15 |
| B2-5 unsieved | 5.75 |
| B2-5 sieved | 5.7 |
| B2-6 unsieved | 5.58 |
| B2-6 sieved | 5.19 |
| B2-7 unsieved | 4.79 |
| B2-7 sieved | 4.81 |
| B2-8 unsieved | 5.41 |
| B2-8 sieved | 5.19 |
| B2-9 unsieved | 5.89 |
| B2-9 sieved | 5.79 |
| B2-10 unsieved | 5.31 |
| B2-10 sieved | 5.94 |

Extrudates with lower WAI are preferred in ready to eat foods while extrudates having higher WAI would be preferred in cat litter, diapers, pizza crusts, frozen foods, and meat packaging. High mechanical shear as well as high screw speed resulted in enhanced starch gelatinization. These pre-gelatinization starch extrudates would be useful as thickening agents in sausages, jerky, binding, soups, sauces, gravies, donuts, jellies, and mixtures thereof.

It was observed that there are unique differences between the pea starch extrudates, the coarse and fine pea starch feeds, pre-gelatinized tapioca-based starch (Gelpro F800E) and pregelatinized wheat-based starch (Paygel 290). Compositional analyses including total starch, free sugars, protein, ash and calculated fiber on a dry weight basis are summarized in Table 6. In comparison with commercial samples (native tapioca pregel and native wheat pregel), coarse pea starch and fine pea starch contain a significantly higher amount of protein and fiber, and about 30% less total starch. The starch-based compositions derived from the disclosed processing conditions may be incorporated into food and non-food formulations.

TABLE 6
Compositional analysis of starting pea starch
feeds and commercial pregelatinized starches.

| | Total | | | | Calculated |
|---|---|---|---|---|---|
| | Starch | Free Sugars | Protein | Ash | Fiber |
| Sample ID | (wt %) | (wt %) | (wt %) | (wt %) | (wt %) |
| fine pea starch | 67.25% | 0.67% | 8.30% | 1.38% | 21.39% |
| coarse pea starch | 67.21% | 0.49% | 8.18% | 1.34% | 21.78% |
| native tapioca | 95.99% | 0.12% | 0.76% | 0.52% | 2.61% |
| pregel | | | | | |
| Native wheat | 92.84% | 0.32% | 1.13% | 0.31% | 5.40% |
| pregel | | | | | |

The processing conditions described herein may alter the composition of the pea starch particle product to achieve the characteristics for a desired application. As shown in tables 7 and 8, the composition of each pea starch particle product was modified by the thermal and mechanical energy of the processing conditions.

TABLE 7
Compositional analysis of pea starch extrudates using
processing conditions of Batch 1 using low shear.

| | Total | | | | |
|---|---|---|---|---|---|
| Sample | Starch | Free Sugars | Protein | Ash | Calculated |
| ID | (wt % ) | (wt % ) | (wt %) | (wt % ) | Fiber (wt % ) |
| B1-1 | 72.47% | 1.27% | 8.25% | 1.44% | 16.58% |
| unsieved | | | | | |
| B1-2 | 63.95% | 0.73% | 8.53% | 1.40% | 25.38% |
| unsieved | | | | | |
| B1-3 | 67.80% | 0.80% | 8.95% | 1.36% | 21.09% |
| unsieved | | | | | |
| B1-4 | 79.66% | 1.44% | 7.86% | 1.89% | 9.15% |
| unsieved | | | | | |
| B1-5 | 71.17% | 0.77% | 7.06% | 1.86% | 19.13% |
| unsieved | | | | | |
| B1-6 | 64.40% | 0.65% | 7.72% | 0.00% | 27.23% |
| unsieved | | | | | |
| B1-7 | 64.02% | 0.54% | 7.91% | 1.34% | 26.19% |
| unsieved | | | | | |
| B1-6 | 70.20% | 0.83% | 8.48% | 1.46% | 19.03% |
| sieved | | | | | |
| B1-7 | 67.19% | 0.88% | 8.62% | 1.04% | 22.28% |
| sieved | | | | | |

TABLE 8
Compositional analysis of pea starch extrudates using
processing conditions of Batch 2 using high shear.

| | Total | | | | |
|---|---|---|---|---|---|
| Sample | Starch | Free Sugars | Protein | Ash | Calculated |
| ID | (wt % ) | (wt % ) | (wt % ) | (wt % ) | Fiber (wt % ) |
| B2-1 | 79.24% | 0.87% | 8.31% | 1.32% | 10.27% |
| unsieved | | | | | |
| B2-2 | 75.56% | 0.80% | 8.29% | 1.38% | 13.97% |
| unsieved | | | | | |
| B2-4 | 62.80% | 1.08% | 7.70% | 1.79% | 26.63% |
| unsieved | | | | | |
| B2-5 | 72.61% | 1.03% | 8.10% | 1.77% | 16.48% |
| unsieved | | | | | |
| B2-8 | 84.32% | 1.41% | 8.84% | 1.37% | 4.05% |
| unsieved | | | | | |
| B2-9 | 70.49% | 1.31% | 9.27% | 1.40% | 17.52% |
| unsieved | | | | | |
| B2-3 | 76.01% | 1.45% | 8.73% | 1.77% | 12.04% |
| sieved | | | | | |
| B2-7 | 73.67% | 1.02% | 8.90% | 1.65% | 14.76% |
| sieved | | | | | |
| B2-8 | 81.30% | 0.71% | 7.93% | 1.28% | 8.77% |
| sieved | | | | | |
| B2-9 | 72.99% | 1.12% | 8.90% | 1.38% | 15.61% |
| sieved | | | | | |
| B2-10 | 78.41% | 1.40% | 8.84% | 1.38% | 9.97% |
| sieved | | | | | |

The extrudates may be subsequently treated to purify the starch. Methods of purification include but not limited to absorption and solvent extraction. Further, the extrudates may be recycled through the extruder to generate additional compositions having different product concentration (i.e. increased starch concentration). The additional step would lead to a more purified product with value in several applications.

Another property that was altered by the processing conditions was particle size. Particle size is important in the quality of diverse products manufactured by the food and non-food industry. The results of particle size analysis of extrudates obtained using low mechanical shear are presented in Table 9. Particle size analysis showed that all the sieved extrudates had the smallest size with D50 more than two times smaller than the next in order. The unsieved extrudates varied in particle size, ranging from D50 of 115-243 microns, while granules of coarse pea starch product were approximately one thousand times larger. A notable benefit of the disclosed process is the average particle size may be tailored to meet a product specification. A reduction in particle size influences the appearance, stability, texture, processing capability, and functionality of end products, as well as digestion and palatability. Particle size is important in the texture and mouthfeel of food products. Finally, the pea starch extrudates with strong mechanical properties have potential to be used for manufacturing biodegradable and rigid containers.

TABLE 9
Particle size analysis of pea starch feeds
and low shear product compositions.

| | Particle Size (micron) | | |
|---|---|---|---|
| Sample ID | D10 | D50 | D90 |
| B1-2 sieved | 9.22 | 50.2 | 120 |
| Fine Pea Starch Feed | 18 | 51 | 153 |
| B1-3 sieved | 10.2 | 52.9 | 122 |
| B1-6 sieved | 8.39 | 55 | 131 |
| B1-1 sieved | 11.3 | 55.4 | 121 |
| B1-5 sieved | 12.2 | 56.2 | 126 |
| B1-7 sieved | 9.02 | 56.8 | 126 |
| B1-4 sieved | 12.9 | 59.7 | 137 |
| B1-4 unsieved | 23.1 | 115 | 286 |
| B1-1 unsieved | 21.9 | 126 | 322 |
| B1-2 unsieved | 21.9 | 149 | 384 |
| B1-7 unsieved | 27.9 | 149 | 319 |
| B1-3 unsieved | 29.8 | 151 | 307 |
| B1-6 unsieved | 30.4 | 188 | 418 |
| B1-5 unsieved | 130 | 243 | 447 |
| Coarse Pea Starch Feed | 86 | 1020 | 2330 |

One aspect of the proposed invention relates to applications of the disclosed novel starch-based compositions. More particularly, the inventors have shown the disclosed starch-based compositions function in meat analogues as a complete replacement for methyl cellulose (MC). A patty formulated with the disclosed composition was preferred in sensory attributes compared to a patty made with methyl cellulose. The product formulated with the composition was more meat-like, whereas the MC patty was more elastic, chewy, and firm. Patties cooked with the disclosed starch-based compositions enable a successful replacement of full-fat counterparts and allow the consumer preference of meat doneness. The patty formulated with MC showed burning while those with pea starch particle products varied in the ranking of degrees of doneness. This attribute is not seen using MC. Our invention has shown that composition is important to achieving a texture that can replace MC in foods.

It should be recognized that this disclosure has been described with reference to certain exemplary embodiments, compositions, and uses thereof. However, it will be recognized by those of ordinary skill in the art that various substitutions, modifications, or combinations of any of the exemplary embodiments may be made without departing from the spirit and scope of the disclosure. Thus, the disclosure is not limited by the description of the exemplary embodiments, but rather by the appended claims as originally filed.

1. A pea starch particle product comprising:
about 50 to 85 weight percent starch;
about 4 to 30 weight percent fiber; and
about 5 to 15 weight percent protein;
wherein the pea starch particle product has a particle size of 30 to 300 microns in diameter.

2. The composition of claim 1, wherein the pea starch particle product is produced by a method that includes a step of milling, extrusion, roll pressing, grinding, sieving and combinations thereof.

3. The pea starch particle product of claim 1 wherein the pea starch particle product has a water solubility from about 20% to about 95% and when dispersed in water provides a mixture having a final viscosity from about 300 centipoise to about 2000 centipoise.

4. A method of forming a pea starch particle product, comprising:
(a) drying a pea starch product to form a powder;
(b) mixing the powder with water, producing a mixture;
(c) extruding the mixture thru an extruder producing an extrudate; and
(d) grinding the extrudate producing the pea starch particle product.

5. The method of claim 4, wherein the pea starch is not treated to any chemical or enzyme reaction.

6. The method of claim 4, wherein the powder comprises at least about 4% by weight fiber.

7. The method of claim 4, wherein the powder has been subjected to milling prior to the extruding.

8. The method of claim 4, wherein the extruding is with a single screw extruder or a twin-screw extruder.

9. The method of claim 4, wherein the extruding of the mixture is with a screw configuration selected from the group consisting of a low-shear mixing screw, a high-shear mixing screw, and a combination of a low-shear mixing screw and high-shear mixing screw.

10. The method of claim 4, wherein the extruding is carried out at a temperature from about 80° C. to about 150° C.

11. The method of claim 4, wherein the extruding is carried out at a screw speed from about 100 rpm to about 500 rpm.

12. A starch composition produced by the method of claim 4.

13. A method of making an animal feed or human food product, comprising,
obtaining a recipe for the animal feed or human food product with methyl cellulose as an ingredient, and substituting the methyl cellulose with the pea starch particle product of claim 1.

14. An animal feed or human food product comprising the pea starch particle product of claim 1.

15. A non-food product comprising the pea starch particle product of claim 1.

16. A method of making an animal feed or human food product, comprising,
obtaining a recipe for the animal feed or human food product with oat fiber as an ingredient, and
substituting the oat fiber with the pea starch particle product of claim 1.

17. An animal feed or human food product comprising, the pea starch particle product of claim 1 in combination with a native starch material.

18. A non-food product comprising, the pea starch particle product of claim 1 in combination with a native starch material.

19. A native starch material of claim 17, wherein the native starch material is selected from the group consisting of corn, potato, rice, wheat, tapioca, and combinations thereof.
